(19) United States
(12) Patent Application Publication
(10) Pub. No.: US 2024/0321268 A1
(43) Pub. Date: Sep. 26, 2024

(54) HUMAN-MACHINE INTERACTION METHOD AND APPARATUS, COMPUTER READABLE STORAGE MEDIUM AND ELECTRONIC DEVICE

(71) Applicant: BEIJING HORIZON INFORMATION TECHNOLOGY CO., LTD., Beijing (CN)

(72) Inventors: Yichen GONG, Beijing (CN); Ziyang WANG, Beijing (CN)

(73) Assignee: BEIJING HORIZON INFORMATION TECHNOLOGY CO., LTD., Beijing (CN)

(21) Appl. No.: 18/589,639

(22) Filed: Feb. 28, 2024

(30) Foreign Application Priority Data
Mar. 23, 2023 (CN) 202310296836.X

(51) Int. Cl. G10L 15/18; G06F 3/01; G10L 15/06; G10L 15/22; G06V 40/18

(52) U.S. Cl. CPC G10L 15/1815; G06F 3/013; G10L 15/063; G10L 15/22; G06V 40/18; G10L 2015/0635

(57) ABSTRACT

Embodiments of the present disclosure disclose a human-machine interaction method, an apparatus, a computer-readable storage medium, and an electronic device, wherein the method includes: in response to receiving target interaction information, performing semantic recognition on the target interaction information to obtain target semantic information; in response to the target semantic information being incomplete, determining whether there is to-be-combined semantic information cached in a preset semantic state record library; in response to presence of the to-be-combined semantic information in the semantic state record library, generating complete semantic information based on the target semantic information and the to-be-combined semantic information; updating the to-be-combined semantic information in the semantic state record library based on the target semantic information; and based on the complete semantic information, determining a target controlled object and a control mode for controlling the target controlled object, and generating a control instruction corresponding to the control mode.

### CROSS-REFERENCE TO RELATED APPLICATIONS

The present application claims priority to Chinese Patent Application No. 202310296836X, entitled “HUMAN-MACHINE INTERACTION METHOD AND APPARATUS, COMPUTER READABLE STORAGE MEDIUM AND ELECTRONIC DEVICE”, filed with the China National Intellectual Property Administration on Mar. 23, 2023, the content of which is hereby incorporated by reference in its entirety.

### TECHNICAL FIELD

The present disclosure relates to the field of computer technology, and in particular to a human-machine interaction method and apparatus, a computer-readable storage medium, and an electronic device.

### BACKGROUND

With the development of artificial intelligence technology, there are more and more application scenarios for human-machine interaction. Users may interact with devices through speech, gestures, eyes and other ways. For example, if a user is in the vehicle, the windows, air conditioner and other device may be controlled by speech, so that his or her hands may be freed and traffic hazards may be avoided; and when the vehicle stops, he or she may experience many functions of the intelligent device in the cabin through gestures, eyes and other ways.

A multimodal interaction scheme refers to the combination of multiple human-machine interaction modes, such as speech and gesture, to control the device to perform corresponding operations. The current multimodal interaction scheme typically collects multiple types of interaction information such as speech and gesture at one time, fuses these interaction information, and utilizes the information obtained after fusion for recognition to improve recognition accuracy. However, in practical application scenarios, the interaction information sent by the user is often incomplete, and if incomplete interaction information is used in multimodal interaction, it will cause the device to incorrectly recognize the user's intent.

### SUMMARY

In order to solve the above technical problems, embodiments of the present disclosure provide a human-machine interaction method, and apparatus, a computer-readable storage medium, and an electronic device.

Embodiments of the present disclosure provide a human-machine interaction method, including: in response to receiving target interaction information collected when a target user interacts with a target device according to a first interaction mode, performing semantic recognition on the target interaction information to obtain target semantic information; determining completeness of the target semantic information; in response to the target semantic information being incomplete, determining whether there is to-be-combined semantic information cached in a preset semantic state record library, wherein the to-be-combined semantic information is semantic information obtained when the target user interacts with the target device according to at least one second interaction mode during a target interaction phase; in response to presence of the to-be-combined semantic information in the semantic state record library, generating complete semantic information based on the target semantic information and the to-be-combined semantic information; updating the to-be-combined semantic information in the semantic state record library based on the target semantic information; and based on the complete semantic information, determining a target controlled object and a control mode for controlling the target controlled object, and generating a control instruction corresponding to the control mode.

According to another aspect of embodiments of the present disclosure, there is provided a human-machine interaction apparatus, including: a recognition module configured for, in response to receiving target interaction information collected when a target user interacts with a target device according to a first interaction mode, performing semantic recognition on target interaction information to obtain target semantic information; a first determination module configured for determining completeness of the target semantic information; a second determination module configured for, in response to the target semantic information being incomplete, determining whether there is to-be-combined semantic information cached in a preset semantic state record library, wherein the to-be-combined semantic information is semantic information obtained when the target user interacts with the target device according to at least one second interaction mode during a target interaction phase; a first generation module configured for, in response to presence of the to-be-combined semantic information in the semantic state record library, generating complete semantic information based on the target semantic information and the to-be-combined semantic information; a first update module configured for updating the to-be-combined semantic information in the semantic state record library based on the target semantic information; and a second generation module configured for, based on the complete semantic information, determining a target controlled object and a control mode for controlling the target controlled object, and generating a control instruction corresponding to the control mode.

According to another aspect of embodiments of the present disclosure, there is provided a computer-readable storage medium, in which a computer program is stored, the computer program is configured for being executed by a processor to implement the human-machine interaction method as described above.

According to another aspect of embodiments of the present disclosure, there is provided an electronic device, including: a processor; and a memory configured for storing processor-executable instructions; wherein the processor is configured for reading the executable instructions from the memory and executing the instructions to implement the human-machine interaction method as described above.

According to the human-machine interaction method and apparatus, a computer-readable storage medium, and an electronic device provided in the above embodiments of the present disclosure, first performing semantic recognition on the target interaction information collected when interacting according to the first interaction mode to obtain the target semantic information; determining the completeness of the target semantic information; in response to the target semantic information being incomplete, acquiring, from a semantic state record library, the to-be-combined semantic information cached during the target interaction phase, which is obtained when performing interaction according to the second interaction mode; then generating the complete semantic information based on the target semantic information and the to-be-combined semantic information; updating the to-be-combined semantic information in the semantic state record library; and finally generating target instruction information for controlling the target controlled object based on the complete semantic information. According to the embodiments of the present disclosure, when the target semantic information recognized by an interaction mode is incomplete, the to-be-combined semantic information cached in advance by other interaction modes is acquired, and then the complete semantic information is generated. Compared with the method of fusing and performing recognition on multimodal interaction information at one time, the embodiments of the present disclosure may, in the course of multiple rounds of interaction, effectively utilize semantic information that has been obtained through other interaction modes prior to the current moment to supplement the currently recognized incomplete semantic information, to obtain complete semantic information indicating the user's true intent, and thus more accurately determine the user's true control intent. In addition, by caching the semantic information obtained in advance through various recognition methods, it is possible that the user may interact with the target device using a combination of various interaction methods during multiple rounds of interaction, which greatly improves the convenience of interaction.

The technical solutions of the present disclosure are described below in further detail with reference to the accompanying drawings and embodiments.

### BRIEF DESCRIPTION OF DRAWINGS

FIG. 1 is a diagram of a system to which the present disclosure applies;

FIG. 2 is a flow diagram of a human-machine interaction method in accordance with an exemplary embodiment of the present disclosure;

FIG. 3 is a flow diagram of a human-machine interaction method in accordance with another exemplary embodiment of the present disclosure;

FIG. 4 is a flow diagram of a human-machine interaction method in accordance with another exemplary embodiment of the present disclosure;

FIG. 5 is a flow diagram of a human-machine interaction method in accordance with another exemplary embodiment of the present disclosure;

FIG. 6 is a flow diagram of a human-machine interaction method in accordance with another exemplary embodiment of the present disclosure;

FIG. 7 is a flow diagram of a human-machine interaction method in accordance with another exemplary embodiment of the present disclosure;

FIG. 8 is a flow diagram of a human-machine interaction method in accordance with another exemplary embodiment of the present disclosure;

FIG. 9 is a schematic diagram of a structure of a human-machine interaction apparatus in accordance with an exemplary embodiment of the present disclosure;

FIG. 10 is a schematic diagram of a structure of a human-machine interaction apparatus in accordance with another exemplary embodiment of the present disclosure;

FIG. 11 is a schematic diagram of a structure of an electronic device in accordance with an exemplary embodiment of the present disclosure.

### DETAILED DESCRIPTION OF THE EMBODIMENTS

For the purpose of explaining the present disclosure, exemplary embodiments of the present disclosure will be described in detail below with reference to the accompanying drawings, and it is clear that the described embodiments are only a portion of the embodiments of the present disclosure and not all of the embodiments. It should be understood that the present disclosure is not limited by the exemplary embodiments.

It should be noted that the relative arrangements, numerical expressions, and values of the components and steps set forth in these embodiments do not limit the scope of the present disclosure, unless otherwise specifically stated.

### Application Overview

Current multimodal human-machine interaction methods do not guarantee the completeness of the recognized interaction information, which may easily lead to recognition errors during interaction. Without solving the problem, embodiments of the present disclosure provide a human-machine interaction method that may be applied to a multi-round interaction scenario, wherein when interaction information is obtained through an interaction mode and target semantic information is obtained by performing recognition on the interaction information, if it is determined that the target semantic information is incomplete, to-be-combined semantic information cached in the course of the multi-round interaction is obtained, and the target semantic information and the to-be-combined semantic information are combined to form complete semantic information for recognition, so as to accurately control a target controlled object.

### Exemplary System

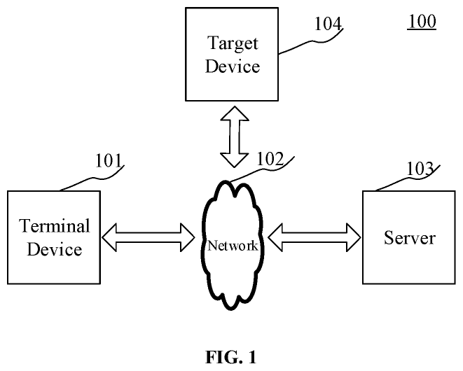

FIG. 1 illustrates an exemplary system architecture 100 for a human-machine interaction method or human-machine interaction apparatus to which embodiments of the present disclosure may be applied.

As shown in FIG. 1, the system architecture 100 may include a terminal device 101, a network 102, a server 103, and a target device 104. The network 102 is used to provide a medium for a communication link between the end device 101 and the server 103. The network 102 may include various connection types, such as wired communication link, wireless communication link fiber optic cables, or the like.

A user may use the terminal device 101 to interact with the server 103 via the network 102 to receive or send messages and the like. Various communication client applications may be installed on the terminal device 101, such as a speech recognition application, an image recognition application, and the like.

The terminal device 101 may be a variety of electronic devices including, but not limited to, mobile terminals such as in-vehicle terminals, cellular telephones, laptop computers, digital broadcast receivers, PDAs (Personal Digital Assistants), PADs (tablets), PMPs (Portable Multimedia Players), and the like, and fixed terminals such as digital TVs, desktop computers, and the like.

The target device 104 may be various types of electronic devices, such as a vehicle, an intelligent home appliance, an industrial device, etc., and the target device 104 may contain a plurality of controlled objects. For example, when the target device 104 is a vehicle, the controlled objects may include an in-vehicle player, in-vehicle air-conditioning, a window, a seat, and the like. It is noted that the terminal device 101 may be provided in the target device 104. For example, when the target device 104 is a vehicle, the terminal device 101 may be a vehicle terminal. The terminal device 101 may also be provided outside the target device 104. For example, the target device 104 is a smart home appliance, then the terminal device 101 may be a cell phone, where the cell phone may keep in a communication connection with and control the smart home appliance.

The server 103 may be a server that provides various services, such as background servers that recognizes user speech, user images, etc. uploaded by the terminal device 101 or the target device 104. The background server may recognize the received interaction information to obtain semantic information, and generate target instruction information for controlling the target controlled object based on the semantic information. The background server may further feedback the target instruction information to the terminal device 101 or the target device 104.

It is to be noted that the human-machine interaction method provided in the embodiments of the present disclosure may be executed by the server 103 or may be executed by the terminal device 101 or the target device 104, and accordingly, the human-machine interaction apparatus may be disposed in the server 103, or may be disposed in the terminal device 101 or the target device 104.

It should be understood that the number of terminal devices 101, networks 102, servers 103, and target devices 104 in FIG. 1 is merely illustrative. Depending on the implementation needs, there may be any number of terminal devices 101, networks 102, servers 103, and target devices 104. For example, in the case where the interaction information does not need to be obtained from a remote location, the above-described system architecture may include only the terminal devices 101 or the target devices 104, without the network 102.

### Exemplary Method

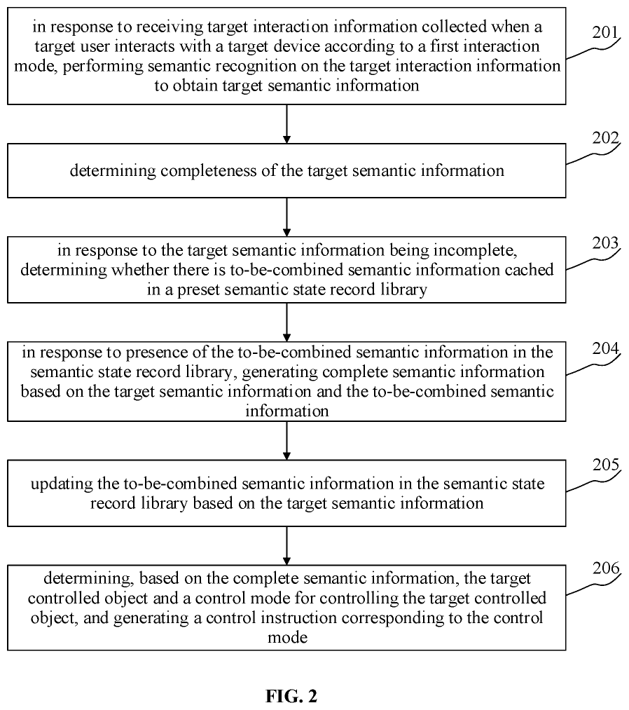

FIG. 2 is a flow diagram of a human-machine interaction method in accordance with an exemplary embodiment of the present disclosure. This embodiment may be applied to an electronic device (e.g., terminal device 101, server 103 or target device 104 as shown in FIG. 1), and as shown in FIG. 2, the method includes the following steps:

Step 201, in response to receiving target interaction information collected when a target user interacts with a target device according to a first interaction mode, performing semantic recognition on the target interaction information to obtain target semantic information.

In this embodiment, in response to receiving the target interaction information collected when the target user interacts with the target device (i.e., the target device 104 shown in FIG. 1) according to the first interaction mode, the electronic device may perform semantic recognition on the target interaction information to obtain the target semantic information. The first interaction mode may be any one of modes such as a speech interaction mode, a gesture interaction mode, a line-of-sight interaction mode, and the like, and accordingly, the target interaction information may be any one of types of information such as a speech signal, a gesture image, an eye image, and the like, and the method adopted for performing semantic recognition on the target interaction information may be any one of a speech recognition, a gesture recognition, a line-of-sight recognition, and the like.

Typically, the target semantic information may be textual information for representing the semantics expressed by the target user when interacting with the target device.

As an example, when a user conducts human-machine interaction with a target device by speech, ASR (Automatic Speech Recognition) technology may be used for speech recognition to obtain target semantic information.

Step 202, determining completeness of the target semantic information.

In this embodiment, the electronic device may perform semantic completeness analysis on the target semantic information to determine the completeness of the target semantic information. The semantic completeness analysis on the target semantic information may be implemented using a semantic completeness analysis model, e.g., a semantic completeness analysis model based on TCN (Temporal Convolutional Network).

Typically, complete semantic information may include target controlled object information and target instruction information. If the target semantic information does not contain both the controlled object information and the target instruction information, the target semantic information is determined to be incomplete.

As an example, the first interaction mode is a speech interaction mode, that is, the target user conducts human-machine interaction with the target device by speech. If the recognized target semantic information is “air conditioner high temperature”, “air conditioner”, it cannot be determined how to control the air conditioner according to high temperature”, since the information contains only the target controlled object information, that is, the target semantic information does not contain the target instruction information, then the target semantic information is determined to be incomplete.

Step 203, in response to the target semantic information being incomplete, determining whether there is to-be-combined semantic information cached in a preset semantic state record library.

In this embodiment, the electronic device may determine, in response to the target semantic information being incomplete, whether there is to-be-combined semantic information cached in a preset semantic state record library, wherein the to-be-combined semantic information is semantic information obtained when the target user interacts with the target device according to at least one second interaction mode during the target interaction phase.

Specifically, the target interaction phase may be a phase including one-time multi-round interaction. Typically, one-time multi-round interaction refers to the phase experienced by the target device from a moment when the target device enters an interaction wake-up state from an interaction dormant state to a moment when the target device enters the interaction dormant state once more, within which the target user may perform multiple rounds of interaction with the target device.

The second interaction mode may be an interaction mode different from the first interaction mode, and the second interaction mode may have at least one type. For example, if the first interaction mode is a speech interaction mode, the second interaction mode may include, but is not limited to, at least one of the followings: a gesture interaction mode, a line-of-sight interaction mode, and the like.

The above-described semantic state record library may be set up locally in the electronic device or in a remote device. Typically, the to-be-combined semantic information cached in the semantic state record library is the semantic information cached within the above-described target interaction phase, that is, any one of the multiple rounds of interaction process may use the cached to-be-combined semantic information.

Step 204, in response to presence of the to-be-combined semantic information in the semantic state record library, generating complete semantic information based on the target semantic information and the to-be-combined semantic information.

In this embodiment, the electronic device may generate, in response to the presence of the to-be-combined semantic information in the semantic state record library, the complete semantic information based on the target semantic information and the to-be-combined semantic information.

Specifically, the target controlled object information and/or the target instruction information may be extracted from the target semantic information, and the extracted target controlled object information and/or the target instruction information may be combined with the to-be-combined semantic information to generate the complete semantic information containing the target controlled object information and the target instruction information.

As an example, if the recognized incomplete target semantic information is “air conditioner high temperature”, the information only contains the target controlled object information “air conditioner” and does not contain the target instruction information. At this time, if the semantic state record library contains the to-be-combined information “raise the temperature by one degree” obtained in advance through gesture recognition (e.g., the target user's gesture is to stick out and point one finger upward), the to-be-combined information may be extracted from the semantic state record library, so as to be combined into the complete semantic information “raise the air conditioning temperature by one degree”.

For another example, if the incomplete target semantic information as recognized is “open”, which contains only the target instruction information but not the target controlled object information, that is, the electronic device cannot determine what kind of controlled object to open. At this time, if the semantic state record library contains the to-be-combined information “the left side window” obtained in advance through line-of-sight recognition, the to-be-combined information may be extracted from the semantic state record library, so as to be combined into complete semantic information “open the left side window”.

Optionally, if there is a plurality of target controlled object information or a plurality of target instruction information in the above semantic state record library, target controlled object information or target instruction information which is last cached may be determined as the to-be-combined information, so as to make the target controlled object information or the target instruction information more explicit.

Step 205, updating the to-be-combined semantic information in the semantic state record library based on the target semantic information.

In this embodiment, the electronic device may update the to-be-combined semantic information in the semantic state record library based on the target semantic information.

Specifically, the electronic device may store the target controlled object information and/or the target instruction information included in the target semantic information, as to-be-combined information, directly into the semantic state record library; and alternatively, the electronic device may replace the target controlled object information already present in the semantic state record library with the target controlled object information included in the target semantic information, or replace the semantic instruction information already present in the semantic state record library with the target instruction information included in the target semantic information.

Step 206, determining, based on the complete semantic information, the target controlled object and a control mode for controlling the target controlled object, and generating a control instruction corresponding to the control mode.

In this embodiment, the electronic device may determine, based on the complete semantic information, the target controlled object and the control mode for controlling the target controlled object, and generate the control instruction corresponding to the control mode.

Specifically, the complete semantic information includes the target controlled object information and the target instruction information, wherein the target controlled object may be determined according to the target controlled object information, and the control mode for controlling the target controlled object may be determined according to the target instruction information. For example, if the target controlled object information is “air conditioner” and the target instruction information is “raise by one degree”, the control instruction of raising the air conditioning temperature by one degree may be generated.

The method provided in the above embodiment of the present disclosure includes first performing semantic recognition on the target interaction information collected when interacting according to the first interaction mode to obtain the target semantic information; determining the completeness of the target semantic information; in response to the target semantic information being incomplete, acquiring, from a semantic state record library, the to-be-combined semantic information cached during the target interaction phase, which is obtained when performing interaction according to the second interaction mode; then generating the complete semantic information based on the target semantic information and the to-be-combined semantic information; updating the to-be-combined semantic information in the semantic state record library; and finally generating target instruction information for controlling the target controlled object based on the complete semantic information. According to the embodiments of the present disclosure, when the target semantic information recognized by an interaction mode is incomplete, the to-be-combined semantic information cached in advance by other interaction modes is acquired, and then the complete semantic information is generated. Compared with the method of fusing and performing recognition on multimodal interaction information at one time, the embodiments of the present disclosure may, in the course of multiple rounds of interaction, effectively utilize semantic information that has been obtained through other interaction modes prior to the current moment to supplement the currently recognized incomplete semantic information, to obtain complete semantic information indicating the user's true intent, and thus more accurately determine the user's true control intent. In addition, by caching the semantic information obtained in advance through various recognition methods, it is possible that the user may interact with the target device using a combination of various interaction methods during multiple rounds of interaction, which greatly improves the convenience of interaction.

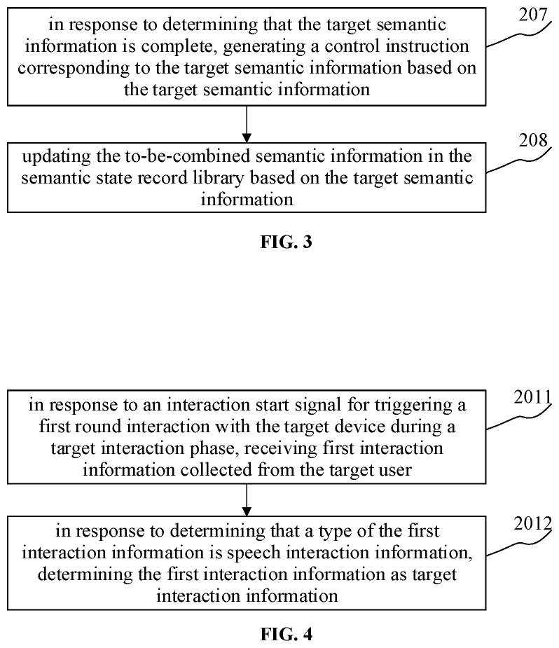

In some optional implementations, as shown in FIG. 3, after step 202, the method further includes:

Step 207, in response to determining that the target semantic information is complete, generating a control instruction corresponding to the target semantic information based on the target semantic information.

When it is determined that the target semantic information is complete, i.e., the target controlled object and the target instruction information may be extracted from the target semantic information, the control instruction for controlling the target controlled object may be generated according to the process as described in step 206 above.

Step 208, updating the to-be-combined semantic information in the semantic state record library based on the target semantic information.

Specifically, the electronic device may store the target controlled object information and the target instruction information included in the target semantic information, as to-be-combined information, directly into the semantic state record library; and alternatively, the electronic device may replace the target controlled object information already present in the semantic state record library with the target controlled object information included in the target semantic information, and replace the target instruction information already present in the semantic state record library with the target instruction information included in the target semantic information.

The present embodiment realizes that when the target semantic information is determined to be complete, a control instruction for controlling the target controlled object is directly generated, and the to-be-combined semantic information in the semantic state record library is updated based on the complete target semantic information, so as to realize a rapid control of the target controlled object and provide semantic supplementation for the next round of interaction, improving the efficiency of the multimodal multi-round interaction.

In some optional implementations, after step 203, the method further includes:

In response to determining that there is not the to-be-combined semantic information in the semantic state record library, generating the to-be-combined semantic information based on the target semantic information, and storing the to-be-combined semantic information into the semantic state record library.

Specifically, if the current interaction is in a first-round interaction under the above-described target interaction phase (i.e., multiple rounds of interaction), there is not the to-be-combined semantic information cached in the semantic state record library, and then, the target semantic information may be stored into the semantic state record library as to-be-combined information, or the target controlled object information and/or the target instruction information included in the target semantic information may be stored into the semantic state record library as to-be-combined semantic information.

This embodiment realizes generating and storing to-be-combined semantic information into a semantic state record library in the first-round interaction during the target interaction phase, providing support for semantic completeness for subsequent interactions, so that complete semantic information may be obtained as soon as possible during the target interaction phase, and the efficiency of the interaction may be improved.

In some optional implementations, as shown in FIG. 4, Step 201 includes:

Step 2011, in response to an interaction start signal for triggering a first round interaction with the target device during a target interaction phase, receiving first interaction information collected from the target user.

Wherein, the interaction start signal is a signal that instructs the electronic device to start receiving interaction information when each round of interaction starts, for example, the interaction start signal may be a specific speech signal, a gesture signal, etc., and the interaction start signal may also be a signal that is automatically triggered when the electronic device monitors in real time that the target user sends any type of signal such as a speech signal, a gesture signal, or the like.

Step 2012, in response to determining that a type of the first interaction information is speech interaction information, determining the first interaction information as target interaction information.

That is, in the first-round interaction during the target interaction phase, recognition is performed only on the speech interaction information, and if other types of interaction information are collected, the other types of interaction information are discarded.

The present embodiment realizes that the interaction is performed in a first-round interaction of a multi-round interaction by using a speech interaction mode. Because the speech interaction mode expresses a true intent of the target user with higher accuracy compared to the gesture interaction, line-of-sight interaction, and other modes, the use of the speech interaction mode for the first-round interaction may improve the accuracy of the multi-modal multi-round interaction and reduce the risk of misrecognition.

In some optional implementations, as shown in FIG. 5, Step 201 includes:

Step 2013, in response to an interaction start signal for triggering a non-first-round interaction with the target device during a target interaction phase, receiving second interaction information collected when interacting with the target user according to any of the predetermined at least one interaction mode.

Step 2014, generating target interaction information based on the second interaction information.

That is, starting from the second-round interaction in the target interaction phrase, any type of interaction information may be used as the target interaction information for recognition in the current-round interaction. For example, the first-round interaction uses a speech interaction mode, and for the second-round interaction and subsequent interactions, a speech interaction mode may be used to collect a speech signal as the target interaction information, or a gesture interaction mode may be used to collect a gesture image as the target interaction information; or a line-of-sight interaction mode may be used to collect an eye image as the target interaction information.

Step 2015, performing semantic recognition on the target interaction information according to the semantic recognition mode corresponding to the target interaction information to obtain the target semantic information.

As an example, if the target interaction information is a gesture image, recognition may be performed on the gesture image according to a gesture recognition mode to obtain target semantic information indicating a gesture intent of the target user; and if the target interaction information is an eye image, recognition may be performed on the eye image according to a line-of-sight recognition mode to obtain target semantic information indicating a line-of-sight intent of the target user.

The present embodiment realizes that the interaction is performed by using any type of interaction mode starting from the second-round interaction of multi-round interaction, which may avoid the risk of misrecognition caused by the use of too many types of speech interaction modes in the first-round interaction, and effectively improve the accuracy and efficiency of the multi-modal interaction starting from the second-round interaction.

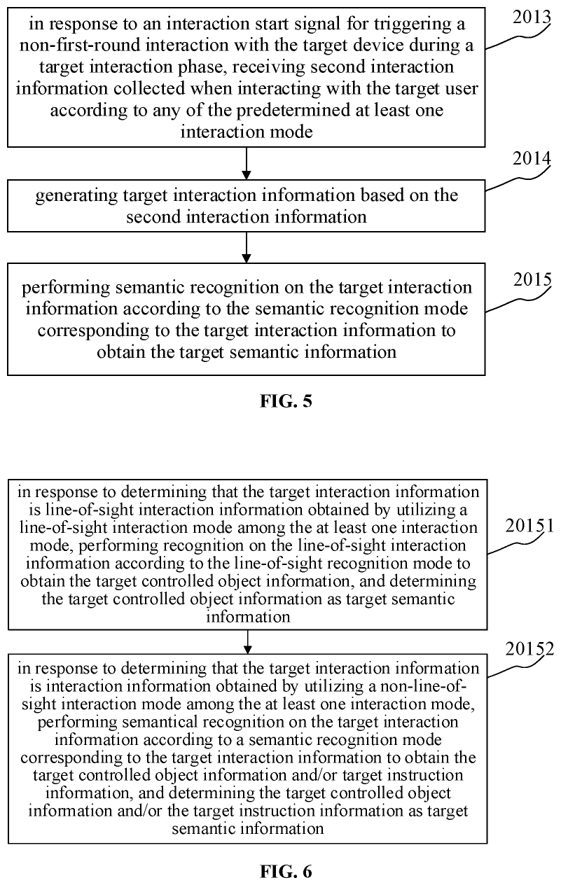

In some optional implementations, as shown in FIG. 6, Step 2015 includes:

Step 20151, in response to determining that the target interaction information is line-of-sight interaction information obtained by utilizing a line-of-sight interaction mode among the at least one interaction mode, performing recognition on the line-of-sight interaction information according to the line-of-sight recognition mode to obtain the target controlled object information, and determining the target controlled object information as target semantic information.

The line-of-sight interaction information may be an eye image of the target user, and the line-of-sight recognition mode is a mode of performing line-of-sight recognition on the eye image. A result of the line-of-sight recognition typically includes a target line-of-sight angle of the target user, and the electronic device may determine the target controlled object information corresponding to the recognized target line-of-sight angle according to a pre-set correspondence between the line-of-sight angle and the controlled object information. The electronic device may then determine the target controlled object information as target semantic information. That is, only the target controlled object information corresponding to the line-of-sight interaction information is recognized, and no instruction information is recognized on the line-of-sight interaction information.

Step 20152, in response to determining that the target interaction information is interaction information obtained by utilizing a non-line-of-sight interaction mode among the at least one interaction mode, performing semantical recognition on the target interaction information according to a semantic recognition mode corresponding to the target interaction information to obtain the target controlled object information and/or target instruction information, and determining the target controlled object information and/or the target instruction information as target semantic information.

That is, when the target interaction information is not line-of-sight interaction information, both recognition for the controlled object and recognition for the instruction information may be performed on the target interaction information to obtain target controlled object information and/or target instruction information.

According to the present embodiment, by starting from the second-round interaction in the target interaction phrase, recognition is performed only for the controlled object on the line-of-sight interaction information, and recognition is not performed for the instruction information, thereby effectively circumventing the drawback of high uncertainty of the instruction information expressed by the line-of-sight information and helping to improve the accuracy of multimodal multi-round interaction.

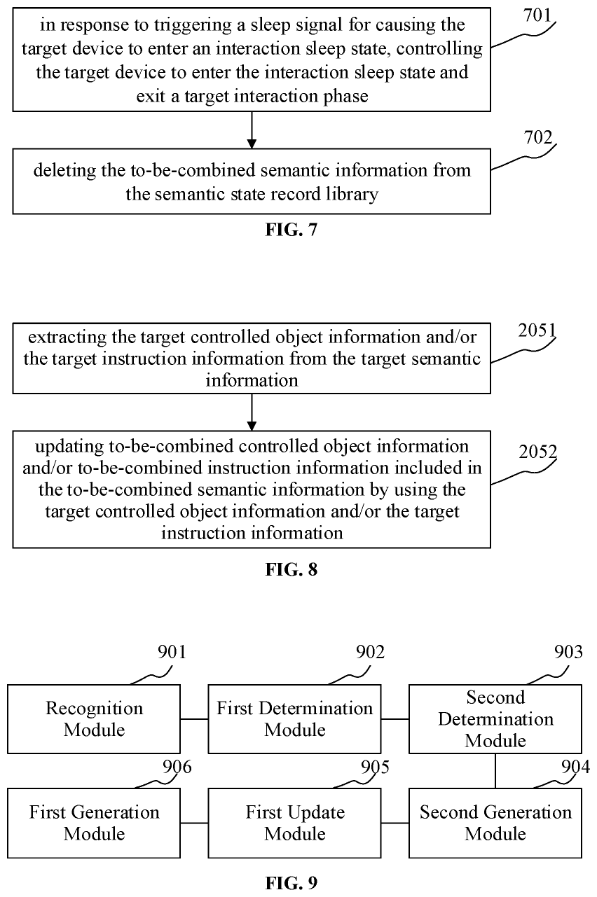

In some optional implementations, as shown in FIG. 7, the method further includes:

Step 701, in response to triggering a sleep signal for causing the target device to enter an interaction sleep state, controlling the target device to enter the interaction sleep state and exit a target interaction phase.

As an example, the sleep signal may be sent by the target user, for example, when it is recognized that the target user send a speech signal (e.g., the speech “goodbye”) for instructing the target device to enter the interaction sleep state, or a gesture signal (e.g., a gesture of waving a hand) for instructing the target device to enter the interaction sleep state, the target device is controlled to enter the interaction sleep state. The sleep signal may also be generated automatically. For example, when an interaction start signal for a new round of interaction is not triggered within a preset period of time, a sleep signal is generated and the target device enters the interaction sleep state. In the interaction sleep state, the target device stops human-machine interaction with the target user and is no longer controlled by the at least one of the above-described interaction modes.

Step 702, deleting the to-be-combined semantic information from the semantic state record library.

The present embodiment realizes that when the target device enters the interaction sleep state, the to-be-combined semantic information in the semantic state record library is deleted timely, so as to avoid interference of the to-be-combined semantic information in the semantic state record library to the interaction when the target device enters the wake-up state next time and performs a multi-round interaction with the target user, improving the accuracy of the multimodal multi-round interaction and saving storage resources in the memory used for storing the to-be-combined semantic information.

In some optional implementations, as shown in FIG. 8, Step 205 includes:

Step 2051, extracting the target controlled object information and/or the target instruction information from the target semantic information.

Wherein the target controlled object information indicates a target controlled object. As an example, when the above-described target device is a vehicle, the target controlled object may be an air conditioner, a multimedia device, a window, a dashboard, a seat, and the like in the vehicle. The target instruction information is information indicating a control mode performed on the target controlled object, for example, information indicating adjusting the temperature of the air conditioner, information indicating adjusting an opening or closing state of the window, etc.

Optionally, the target semantic information may be textual information, then the target controlled object information and the target instruction information may be words, phrases or expressions, etc. extracted from the text.

Step 2052, updating to-be-combined controlled object information and/or to-be-combined instruction information included in the to-be-combined semantic information by using the target controlled object information and/or the target instruction information.

Specifically, the electronic device may store, the target controlled object information as the to-be-combined controlled object information and/or the target instruction information as the to-be-combined instruction information, directly into the semantic state record library; or, the electronic device may replace the to-be-combined controlled object information already present in the semantic state record library with the target controlled object information, and/or replace the to-be-combined instruction information already present in the semantic state record library with the target instruction information.

The present embodiment, by utilizing the target controlled object information and/or target instruction information in the target semantic information to update the to-be-combined controlled object information and/or the to-be-combined instruction information included in the to-be-combined semantic information, realizes that the semantic state record library stores the to-be-combined controlled object information and the to-be-combined instruction information, respectively, and thereby the to-be-combined semantic information in the semantic state record library may be updated more targetedly, helping to targetedly extract currently missing semantic information from the semantic state record library when the complete semantic information is generated, thereby improving the efficiency of human-machine interaction.

### Exemplary Apparatus

FIG. 9 is a schematic diagram of a structure of a human-machine interaction apparatus in accordance with an exemplary embodiment of the present disclosure. The present embodiment may be applied to an electronic device, and as shown in FIG. 9, the human-machine interaction apparatus includes: a recognition module 901 configured for, in response to receiving target interaction information collected when a target user interacts with a target device according to a first interaction mode, performing semantic recognition on target interaction information to obtain target semantic information; a first determination module 902 configured for determining completeness of the target semantic information; a second determination module 903 configured for determining whether there is to-be-combined semantic information cached in a preset semantic state record library, in response to the target semantic information being incomplete, wherein the to-be-combined semantic information is semantic information obtained when the target user interacts with the target device according to at least one second interaction mode during the target interaction phase; a first generation module 904 configured for generating, in response to presence of the to-be-combined semantic information in a semantic state record library, complete semantic information based on the target semantic information and the to-be-combined semantic information; a first update module 905 configured for updating the to-be-combined semantic information in the semantic state record library based on the target semantic information; and a second generation module 906 configured for determining a target controlled object and a control mode for controlling the target controlled object, based on the complete semantic information, and to generate a control instruction corresponding to the control mode.

In this embodiment, the recognition module 901 may perform semantic recognition on the target interaction information to obtain the target semantic information, in response to receiving the target interaction information collected when the target user interacts with the target device (i.e., the target device 104 shown in FIG. 1) according to the first interaction mode. The first interaction mode may be any one of a speech interaction mode, a gesture interaction mode, a line-of-sight interaction mode, and the like, and accordingly, the target interaction information may be any one of types of information such as a speech signal, a gesture image, an eye image, and the like, and the method adopted for performing semantic recognition on the target interaction information may be any one of the methods of a speech recognition, a gesture recognition, a line-of-sight recognition, and the like.

Typically, the target semantic information may be textual information for representing the semantics expressed when the target user interacts with the target device.

As an example, when a user conducts human-machine interaction with a target device by speech, ASR (Automatic Speech Recognition) technology may be used for speech recognition to obtain target semantic information.

In this embodiment, the first determination module 902 may perform semantic completeness analysis on the target semantic information to determine the completeness of the target semantic information. The semantic completeness analysis on the target semantic information may be implemented by using a semantic completeness analysis model, e.g., a semantic completeness analysis model established based on TCN (Temporal Convolutional Network).

Typically, the complete semantic information may include the target controlled object information and the target instruction information. If the target semantic information does not contain both the controlled object information and the target instruction information, the target semantic information is determined to be incomplete.

As an example, the first interaction mode is a speech interaction mode, i.e., the target user conducts human-machine interaction with the target device by speech. If the recognized target semantic information is “air conditioner high temperature”, it is determined that the target semantic information is incomplete it cannot be determined how to control the air conditioner according to “high temperature”, since the information contains only the target controlled object information “air conditioner”, that is, the target semantic information does not contain the target instruction information, then the target semantic information is determined to be incomplete.

In this embodiment, the second determination module 903 may, in response to the target semantic information being incomplete, determine whether there is to-be-combined semantic information cached in a preset semantic state record library. The to-be-combined semantic information is semantic information obtained when the target user interacts with the target device according to at least one the second interaction mode during the target interaction phase.

Specifically, the target interaction phase may be a phase including one-time multi-round interaction. Typically, one-time multi-round interaction refers to the phase experienced by the target device from a moment when the target device enters an interaction wake-up state from an interaction dormant state to a moment when the target device enters the interaction dormant state once more, within which the target user may perform multiple rounds of interaction with the target device.

The second interaction mode may be an interaction mode different from the first interaction mode, and the second interaction mode may have at least one type. For example, if the first interaction mode is a speech interaction mode, the second interaction mode may include, but is not limited to, at least one of the followings: a gesture interaction mode, a line-of-sight interaction mode, and the like.

The above-described semantic state record library may be set up locally in the electronic device or in a remote device. Typically, the to-be-combined semantic information cached in the semantic state record library is the semantic information cached within the above-described target interaction phase, that is, any one of the multiple rounds of interaction process may use the cached to-be-combined semantic information.

In this embodiment, the first generation module 904 may generate complete semantic information based on the target semantic information and the to-be-combined semantic information, in response to the presence of the to-be-combined semantic information in the semantic state record library.

Specifically, the target controlled object information and/or the target instruction information may be extracted from the target semantic information, and the extracted target controlled object information and/or the target instruction information may be combined with the to-be-combined semantic information to generate the complete semantic information containing the target controlled object information and the target instruction information.

In this embodiment, the first update module 905 may update the to-be-combined semantic information in the semantic state record library based on the target semantic information.

Specifically, the first update module 905 may store the target controlled object information and/or the target instruction information included in the target semantic information, as to-be-combined information, directly into the semantic state record library; and alternatively, the first update module 905 may replace the target controlled object information already present in the semantic state record library with the target controlled object information included in the target semantic information, or replace the target instruction information already present in the semantic state record library with the target instruction information included in the target semantic information.

In this embodiment, the second generation module 906 may determine, based on the complete semantic information, the target controlled object and a control mode for controlling the target controlled object, and generate a control instruction corresponding to the control mode.

Specifically, the complete semantic information includes the target controlled object information and the target instruction information, wherein the target controlled object may be determined according to the target controlled object information, and the control mode for controlling the target controlled object may be determined according to the target instruction information. For example, if the target controlled object information is “air conditioner” and the target instruction information is “raise one degree”, the control instruction of raising the air conditioning temperature by one degree may be generated.

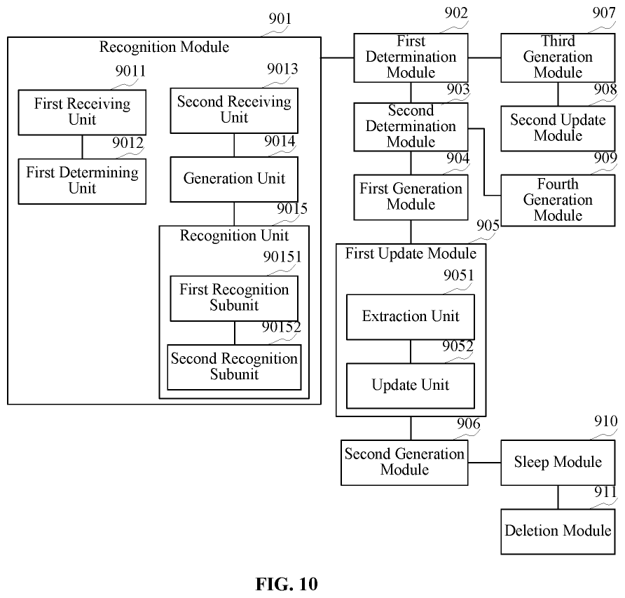

Referring to FIG. 10, FIG. 10 is a schematic diagram of a structure of a human-machine interaction apparatus in accordance with another exemplary embodiment of the present disclosure.

In some optional implementations, the apparatus further includes: a third generation module 907 configured for generating a control instruction corresponding to the target semantic information based on the target semantic information, in response to determining that the target semantic information is complete; and a second update module 908 configured for updating the to-be-combined semantic information in the semantic state record library based on the target semantic information.

In some optional implementations, the apparatus further includes: a fourth generation module 909 configured for generating the to-be-combined semantic information based on the target semantic information in response to determining that there is not the to-be-combined semantic information in the semantic state record library, and storing the to-be-combined semantic information into the semantic state record library.

In some optional implementations, the recognition module 901 includes: a first receiving unit 9011 configured for receiving the first interaction information collected from the target user, in response to an interaction start signal for triggering a first-round interaction with the target device during a target interaction phase; a first determining unit 9012 configured for determining the first interaction information as target interaction information, in response to determining that a type of the first interaction information is speech interaction information.

In some optional implementations, the recognition module 901 includes: a second receiving unit 9013 configured for receiving for triggering second interaction information collected when interacting with the target user in accordance with any of the preset at least one interaction mode, in response to an interaction start signal for triggering a non-first-round interaction with the target device during a target interaction phase; a generation unit 9014 configured for generating target interaction information based on the second interaction information; and a recognition unit 9015 configured for performing semantic recognition on the target interaction information according to a semantic recognition mode corresponding to the target interaction information to obtain target semantic information.

In some optional implementations, the recognition unit 9015 includes: a first recognition subunit 90151 configured for performing recognition on line-of-sight interaction information according to the line-of-sight recognition mode to obtain the target controlled object information, and determining the target controlled object information as target semantic information, in response to determining that the target interaction information is the line-of-sight interaction information obtained by utilizing the line-of-sight interaction mode among the at least one interaction mode; the second recognition subunit 90152 configured for performing semantic recognition on the target interaction information according to a semantic recognition mode corresponding to the target interaction information to obtain the target controlled object information and/or the target instruction information, and determining the target controlled object information and/or the target instruction information as the target semantic information, in response to determining that the target interaction information is interaction information obtained by utilizing the non-line-of-sight interaction mode among the at least one interaction mode.

In some optional implementations, the apparatus further includes: a sleep module 910 configured for controlling the target device to enter an interaction sleep state and exit a target interaction phase, in response to triggering a sleep signal for causing the target device to enter an interaction sleep state; and a deletion module 911 configured for deleting the to-be-combined semantic information from the semantic state record library.

In some optional implementations, the first update module 905 includes: an extraction unit 9051 configured for extracting the target controlled object information and/or the target instruction information from the target semantic information; and an update unit 9052 configured for updating to-be-combined controlled object information and/or to-be-combined instruction information included in the to-be-combined semantic information by using the target controlled object information and/or the target instruction information.

The human-machine interaction apparatus provided in the above embodiment of the present disclosure first performs semantic recognition on the target interaction information collected when performing interaction according to a first interaction mode to obtain the target semantic information; determines the completeness of the target semantic information; in response to the target semantic information being incomplete, acquires, from a semantic state record library, the to-be-combined semantic information cached during the target interaction phase, which is obtained when performing interaction according to the second interaction mode; then generates the complete semantic information based on the target semantic information and the to-be-combined semantic information; updates the to-be-combined semantic information in the semantic state record library; and finally generates target instruction information for controlling the target controlled object based on the complete semantic information. The embodiments of the present disclosure realize that when the target semantic information recognized by an interaction mode is incomplete, the to-be-combined semantic information cached in advance by other interaction modes is acquired, and then the complete semantic information is generated. Compared with the method of fusing and performing recognition on the multimodal interaction information at one time, the embodiments of the present disclosure may, in the course of multiple rounds of interaction, effectively utilize semantic information that has been obtained through other interaction modes prior to the current moment to supplement the currently recognized incomplete semantic information, to obtain complete semantic information indicating the user's true intent, and thus more accurately determine the user's true control intent. In addition, by caching the semantic information obtained in advance through various recognition methods, it is possible that the user may interact with the target device using a combination of various interaction methods during multiple rounds of interaction, which greatly improves the convenience of interaction.

### Exemplary Electronic Device

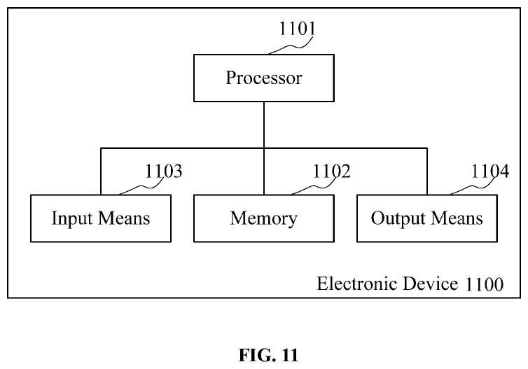

FIG. 11 illustrates a block diagram of an electronic device according to embodiments of the present disclosure.

As shown in FIG. 11, the electronic device 1100 includes one or more processors 1101 and memory 1102.

The processor 1101 may be a central processing unit (CPU) or other form of processing unit having data processing capability and/or instruction execution capability, and may control other components in the electronic device 1100 to perform desired functions.

The memory 1102 may include one or more computer program products, and the computer program products may include various forms of computer-readable storage media, such as volatile memory and/or non-volatile memory. The volatile memory may include, for example, random access memory (RAM), cache, and/or the like. The non-volatile memory may include, for example, read-only memory (ROM), hard disk, flash memory, and the like. One or more computer program instructions may be stored on the computer-readable storage medium, and the processor 1101 may run the program instructions to implement the human-machine interaction methods according to the various embodiments of the present disclosure as described above and/or other desired functions. Various contents such as to-be-combined semantic information may also be stored on the computer-readable storage medium.

In one example, the electronic device 1100 may also include: an input means 1103 and an output means 1104, which are interconnected to each other via a bus system and/or other forms of connecting mechanisms (not shown).

For example, in the case where the electronic device is a terminal device 101 or a server 103, the input means 1103 may be means, such as a camera, a microphone, a mouse, a keyboard, and the like, for inputting interaction information such as the types of images, speech signals, and the like. In the case where the electronic means is a stand-alone device, the input means 1103 may be a communication network connector for receiving inputted interaction information such as the types of image, speech signal, etc., from the terminal device 101, the server 103, or a target device 104.

The output means 1104 may output various information, including control commands, to outside. The output means 1104 may include, for example, a display, a speaker, a printer, and a communication network along with remote output means connected thereto, etc.

Of course, for the sake of simplicity, only some of the components of the electronic device 1100 relevant to the present disclosure are shown in FIG. 11, omitting components such as buses, input/output interfaces, and the like. In addition, the electronic device 1100 may include any other appropriate components, depending on the specific application.

### Exemplary Computer Program Product and Computer Readable Storage Medium

In addition to the methods and devices described above, embodiments of the present disclosure may be a computer program product including computer program instructions which, when run by a processor, cause the processor to perform the steps of a method of human-machine interaction according to various embodiments of the present disclosure as described in the above-described “Exemplary Method” section of this specification.

The computer program product may be program code, written with one or any combination of a plurality of programming languages that is configured to perform the operations in the embodiments of the present disclosure. The programming languages include an object-oriented programming language such as Java or C++, and further include a conventional procedural programming language such as a “C” language or a similar programming language. The program code may be entirely or partially executed on a user computing device, executed as an independent software package, partially executed on the user computing device and partially executed on a remote computing device, or entirely executed on the remote computing device or a server.

In addition, embodiments of the present disclosure may be a computer-readable storage medium having stored thereon computer program instructions which, when run by a processor, cause the processor to perform the steps of a method of human-machine interaction according to various embodiments of the present disclosure as described in the above-described “Exemplary Method” portion of this specification.

The computer readable storage medium may be one readable medium or any combination of a plurality of readable media. The readable medium may be a readable signal medium or a readable storage medium. The readable storage medium may include, for example, but not limited to electricity, magnetism, light, electromagnetism, infrared ray, or a semiconductor system, apparatus or device, or any combination of the above. More specific examples (a non-exhaustive list) of the readable storage medium include: an electrical connection with one or more conducting wires, a portable disk, a hard disk, a random access memory (RAM), a read-only memory (ROM), an erasable programmable read-only memory (EPROM or flash memory) or a flash memory, an optical fiber, a portable compact disk read-only memory (CD-ROM), an optical storage device, a magnetic storage device, or any suitable combination of the above.

Basic principles of the present disclosure are described above in combination with the specific embodiments. However, it should be pointed out that the advantages, superiorities, and effects mentioned in the present disclosure are merely examples but are not for limitation, and it cannot be considered that these advantages, superiorities, and effects are necessary for each embodiment of the present disclosure. In addition, specific details of the above disclosure are merely for examples and for ease of understanding, rather than limitations. The foregoing details do not limit that the present disclosure must be implemented by using the foregoing specific details.

Those skilled in the art may make various modifications and variations to the present disclosure without departing from the spirit and scope of the present application. Thus, if these modifications and variations of the present application fall within the scope of the present claims and their technical equivalents, the present disclosure is intended to encompass these modifications and variations as well.

What is claimed is:

1. A human-machine interaction method, including:
in response to receiving target interaction information collected when a target user interacts with a target device according to a first interaction mode, performing semantic recognition on the target interaction information to obtain target semantic information;
determining completeness of the target semantic information;
in response to the target semantic information being incomplete, determining whether there is to-be-combined semantic information cached in a preset semantic state record library, wherein the to-be-combined semantic information is semantic information obtained when the target user interacts with the target device according to at least one second interaction mode during a target interaction phase;
in response to presence of the to-be-combined semantic information in the semantic state record library, generating complete semantic information based on the target semantic information and the to-be-combined semantic information;
updating the to-be-combined semantic information in the semantic state record library based on the target semantic information; and
based on the complete semantic information, determining a target controlled object and a control mode for controlling the target controlled object, and generating a control instruction corresponding to the control mode.

2. The method according to claim 1, further including: after the determining the completeness of the target semantic information,
in response to determining that the target semantic information is complete, generating a control instruction corresponding to the target semantic information based on the target semantic information; and
updating the to-be-combined semantic information in the semantic state record library based on the target semantic information.

3. The method according to claim 1, wherein, the method further includes: after the determining whether there is to-be-combined semantic information cached in a predetermined semantic state record library,
in response to determining that there is not the to-be-combined semantic information in the semantic state record library, generating the to-be-combined semantic information based on the target semantic information, and storing the to-be-combined semantic information into the semantic state record library.

4. The method according to claim 1, wherein the receiving target interaction information collected when the target user interacts with the target device according to the first interaction mode includes:
receiving first interaction information collected from the target user in response to an interaction start signal for triggering a first-round interaction with the target device during the target interaction phase; and
in response to determining that a type of the first interaction information is speech interaction information, determining the first interaction information as the target interaction information.

5. The method according to claim 1, wherein in response to receiving target interaction information collected when a target user interacts with a target device according to a first interaction mode, the performing semantic recognition on the target interaction information to obtain target semantic information includes:
receiving second interaction information collected when interacting with the target user according to any of predetermined at least one interaction mode, in response to an interaction start signal for triggering a non-first-round interaction with the target device during the target interaction phase;
generating the target interaction information based on the second interaction information; and
performing semantic recognition on the target interaction information according to a semantic recognition mode corresponding to the target interaction information to obtain the target semantic information.

6. The method according to claim 5, wherein the performing semantic recognition on the target interaction information according to the semantic recognition mode corresponding to the target interaction information to obtain the target semantic information includes:
in response to determining that the target interaction information is line-of-sight interaction information obtained by utilizing a line-of-sight interaction mode among the at least one interaction mode, performing recognition on the line-of-sight interaction information according to the line-of-sight recognition mode to obtain target controlled object information, and determining the target controlled object information as target semantic information; and
in response to determining that the target interaction information is interaction information obtained by utilizing a non-line-of-sight interaction mode among the at least one interaction mode, performing semantical recognition on the target interaction information according to a semantic recognition mode corresponding to the target interaction information to obtain the target controlled object information and/or target instruction information, and determining the target controlled object information and/or the target instruction information as target semantic information.

7. The method according to claim 1, wherein the method further includes:
in response to triggering a sleep signal for causing the target device to enter an interactive sleep state, controlling the target device to enter the interactive sleep state and exit a target interaction phase; and
deleting the to-be-combined semantic information from the semantic state record library.

8. The method according to claim 1, wherein the updating the to-be-combined semantic information in the semantic state record library based on the target semantic information includes:
extracting target controlled object information and/or target instruction information from the target semantic information; and
updating to-be-combined controlled object information and/or to-be-combined instruction information included in the to-be-combined semantic information by using the target controlled object information and/or the target instruction information.

9. A computer-readable storage medium, in which a computer program is stored, the computer program is configured for being executed by a processor to implement the method according to claim 1.

10. The computer-readable storage medium according to claim 9, wherein the method further includes: after the determining the completeness of the target semantic information,
in response to determining that the target semantic information is complete, generating a control instruction corresponding to the target semantic information based on the target semantic information; and
updating the to-be-combined semantic information in the semantic state record library based on the target semantic information.

11. The computer-readable storage medium according to claim 9, wherein, the method further includes: after the determining whether there is to-be-combined semantic information cached in a predetermined semantic state record library,
in response to determining that there is not the to-be-combined semantic information in the semantic state record library, generating the to-be-combined semantic information based on the target semantic information, and storing the to-be-combined semantic information into the semantic state record library.

12. The computer-readable storage medium according to claim 9, wherein the receiving target interaction information collected when the target user interacts with the target device according to the first interaction mode includes:
receiving first interaction information collected from the target user in response to an interaction start signal for triggering a first-round interaction with the target device during the target interaction phase; and
in response to determining that a type of the first interaction information is speech interaction information, determining the first interaction information as the target interaction information.

13. The computer-readable storage medium according to claim 9, wherein in response to receiving target interaction information collected when a target user interacts with a target device according to a first interaction mode, the performing semantic recognition on the target interaction information to obtain target semantic information includes:
receiving second interaction information collected when interacting with the target user according to any of predetermined at least one interaction mode, in response to an interaction start signal for triggering a non-first-round interaction with the target device during the target interaction phase;
generating the target interaction information based on the second interaction information; and
performing semantic recognition on the target interaction information according to a semantic recognition mode corresponding to the target interaction information to obtain the target semantic information.

14. The computer-readable storage medium according to claim 9, wherein the method further includes:
in response to triggering a sleep signal for causing the target device to enter an interaction sleep state, controlling the target device to enter the interaction sleep state and exit a target interaction phase; and
deleting the to-be-combined semantic information from the semantic state record library.

15. An electronic device, including:
a processor; and
a memory configured for storing processor-executable instructions;
wherein the processor is configured for reading the executable instructions from the memory and executing the instructions to implement the method according to claim 1.

16. The electronic device according to claim 15, wherein the method further includes: after the determining the completeness of the target semantic information,
in response to determining that the target semantic information is complete, generating a control instruction corresponding to the target semantic information based on the target semantic information; and
updating the to-be-combined semantic information in the semantic state record library based on the target semantic information.

17. The electronic device according to claim 15, wherein, the method further includes: after the determining whether there is to-be-combined semantic information cached in a predetermined semantic state record library, in response to determining that there is not the to-be-combined semantic information in the semantic state record library, generating the to-be-combined semantic information based on the target semantic information, and storing the to-be-combined semantic information into the semantic state record library.

18. The electronic device according to claim 15, wherein the receiving target interaction information collected when the target user interacts with the target device according to the first interaction mode includes:
receiving first interaction information collected from the target user in response to an interaction start signal for triggering a first-round interaction with the target device during the target interaction phase; and
in response to determining that a type of the first interaction information is speech interaction information, determining the first interaction information as the target interaction information.

19. The electronic device according to claim 15, wherein in response to receiving target interaction information collected when a target user interacts with a target device according to a first interaction mode, the performing semantic recognition on the target interaction information to obtain target semantic information includes:
receiving second interaction information collected when interacting with the target user according to any of predetermined at least one interaction mode, in response to an interaction start signal for triggering a non-first-round interaction with the target device during the target interaction phase;
generating the target interaction information based on the second interaction information; and
performing semantic recognition on the target interaction information according to a semantic recognition mode corresponding to the target interaction information to obtain the target semantic information.

20. The electronic device according to claim 15, wherein the method further includes:
in response to triggering a sleep signal for causing the target device to enter an interaction sleep state, controlling the target device to enter the interaction sleep state and exit a target interaction phase; and
deleting the to-be-combined semantic information from the semantic state record library.
